(19) United States
(12) Patent Application Publication
(10) Pub. No.: US 2024/0002603 A1
(43) Pub. Date: Jan. 4, 2024

(54) ACTIVE ENERGY RAY-CURABLE COMPOSITION WITH DARK PART CURABILITY

(71) Applicant: TOAGOSEI CO., LTD., Minato-ku, Tokyo (JP)

(72) Inventor: Kazuki OFUSA, Nagoya-shi, Aichi (JP)

(21) Appl. No.: 18/253,509

(22) PCT Filed: Nov. 22, 2021
(86) PCT No.: PCT/JP2021/042846

§ 371 Date: May 18, 2023

(30) Foreign Application Priority Data
Nov. 24, 2020 (JP) 2020-194754

(51) Int. Cl. C08G 75/045; C08F 2/50; C08F 290/06; C08K 5/37; C08K 5/49; B32B 27/16

(52) U.S. Cl. CPC C08G 75/045; C08F 2/50; C08F 290/06; C08K 5/37; C08K 5/49; B32B 27/16

(57) ABSTRACT

An active energy ray-curable composition, including Component (A), Component (B), and Component (C) below, in which the active energy ray-curable composition includes Component (B) at a ratio of from 0.001 to 5 parts by weight and Component (C) at a ratio of from 0.1 to 20 parts by weight, each with respect to a total of 100 parts by weight of Component (A):
Component (A): a compound having an ethylenically unsaturated group, in which the compound is not a compound that has a linear or branched saturated hydrocarbon group having 1 to 7 carbon atoms without a substituent and that has one (meth)acryloyl group,
Component (B): a fluorescent agent, and
Component (C): a reducing agent.

### TECHNICAL FIELD

The present invention relates to an active energy ray-curable composition, preferably relates to an active energy ray-curable composition that can be cured by irradiation with active energy rays such as ultraviolet rays even at a site that is not directly irradiated with active energy rays, and belongs to the technical field.

In the present specification, an acrylate and a methacrylate are collectively represented as a (meth)acrylate, an acryloyl group and a methacryloyl group are collectively represented as a (meth)acryloyl group, and acrylic acid and methacrylic acid are collectively represented as (meth)acrylic acid.

### BACKGROUND ART

Active energy ray-curable compositions that are cured by irradiation with active energy rays such as ultraviolet rays are short in curing time, are excellent in productivity, and are energy-saving. Therefore, active energy ray-curable compositions are used for various purposes such as printing ink, paint, electronic parts, optical members, and building materials.

However, it is difficult to cure a part of active energy ray-curable compositions that is not exposed to active energy rays. Therefore, active energy ray-curable compositions are left uncured at a so-called “dark part” such as a back of three-dimensional parts or a part with light shielding property, and the resulting defects pose a serious problem.

In order to solve this problem, active energy ray-curable compositions which can be cured at a dark part have long been desired. Such performance is called “dark part curability”, “shadow part curability”, “shade part curability”, “dark reaction curability”, “light-shielded part curability” and “dark cure”, and the following suggestions have been made so far.

Hereinafter, in the present specification, these are collectively referred to as “dark part” and “dark part curability”.

In Japanese Patent Application Laid-Open (JP-A) No. H05-097963, a curable resin composition has been proposed which mainly contains a (meth)acrylate monomer having an isocyanate group in the molecule and is further formulated with a photopolymerization initiator and an elastomer component. The composition has been proposed as a composition that can be cured at a shadow part (dark part) with a large gap, which was not possible in the past, since the composition is excellent in photocurability and is cured even by moisture in the air.

In Japanese Patent Application Laid-Open (JP-A) No. H07-109333, a photocurable composition has been proposed which is obtained by formulating a bisphenol-type epoxy resin with a hydroxyl group-containing organic compound and a photopolymerization initiator and further formulating an alkoxysilane thereto, as a photocurable composition having excellent shadow part (dark part) curability.

In Japanese Patent Application Laid-Open (JP-A) No. H07-224132, a photocurable rubber elastic composition has been proposed which includes a polymer that has a propenyloxysilyl group at both terminals of the molecule and has a main chain of polysiloxane or polyether, a cationic polymerizable photopolymerization initiator, and a condensation polymerization promoter, as a composition that exhibits sufficient curability even at a shadow part (dark part) where light does not reach.

In Japanese Patent Application Laid-Open (JP-A) No. H07-224133, a ultraviolet ray-curable silicone resin composition has been proposed which includes a specific reactive polyorganosiloxane having an acryl⋅trialkoxysilyl functional group or an acryl⋅triallyloxysilyl functional group as a terminal group, a silicone oil having a trimethylsilyl group as a terminal group, and a catalytic amount of a silicone moisture curing catalyst and a photosensitizer, as a composition that exhibits sufficient curability even at a shadow part (dark part) where light does not reach.

In Japanese Patent Application Laid-Open (JP-A) No. H08-287890, in order to improve insulation reliability of a gap between an end face of an opening and a peripheral part thereof of a dry battery case where light is difficult to reach, and a positive electrode and a negative electrode, a photocurable composition has been proposed which includes a) a compound having a radically polymerizable ethylenically unsaturated group and b) a photocuring catalyst that has an absorption band in a visible light region or a near-infrared region and that generates radicals upon irradiation with visible light or near-infrared light, as a photocurable composition that includes a visible light or near-infrared light curable resin, which is used for covering and is cured to insulate. It is described that the photocurable composition is superior in curability compared to conventional ultraviolet ray-curable compositions, and peeling or the like is not found.

In Japanese Patent Application Laid-Open (JP-A) No. H11-050014, a dark reaction curable composition has been proposed which includes (A) a compound having a polymerizable unsaturated double bond, (B) a polymerization promoter consisting of a sulfimide compound and an amine compound, and (C) a metal complex which is selected from a metallocene complex, a β-diketone metal complex, and a phthalocyanine metal complex and a metal with which is coordinated is a transition metal selected from Group VIII, Group Ib or Group IIb, as a dark reaction curable composition in which a curing reaction is initiated by light irradiation, and then the curing reaction proceeds by shielding oxygen by affixing of an adherend or the like.

In Japanese Patent Application Laid-Open (JP-A) No. 2000-169821, in order to completely cure an anisotropic conductive adhesive even at a portion of a shadow part (dark part), a method has been proposed which includes irradiating, with ultraviolet rays, an ultraviolet ray-curable anisotropic conductive adhesive that contains, as essential components, (a) an epoxy resin compound containing at least two glycidyl groups in one molecule, (b) a photoactive onium salt, (c) conductive fine particles, and (d) an alkoxysilane compound to generate cationic species from the photoactive onium salt, so that the anisotropic conductive adhesive undergoes living polymerization and is completely cured even at a low curing temperature.

In Japanese Patent Application Laid-Open (JP-A) No. 2012-219180, in order to completely cure a liquid adhesive when adhering a light-transmitting protective material having a light shielding part (dark part) to an image display unit, a two-component redox type adhesive has been proposed which is composed of a first composition that contains a polymerization initiator and a first base agent including a compound having at least one ethylenically unsaturated group, and a second composition that contains a reducing agent capable of decomposing a polymetization initiator and a second base agent including a compound having at least one ethylenically unsaturated group.

In Japanese Patent Application Laid-Open (JP-A) No. 2015-117265, in order to enable a shadow part (dark part) that is not exposed to energy rays to be cured, a photocurable composition has been proposed which consists of (A) component: an acrylic oligomer, (B) component: an acrylic monomer, (C) component: a photoinitiator, and (D) component: a compound having an N-phenylmorpholine skeleton.

In Japanese Patent Application Laid-Open (JP-A) No. 2017-145293, a photocurable resin composition has been proposed which includes a photoinitiator having an absorbance in 10 ppm solution in ethanol of 0.01 or more in a range of from 390 to 420 nm at an optical path length of 10 mm, and a fluorescent agent having a fluorescence emission intensity in 1 ppm solution in acetonitrile of 20 or more in a range of from 390 to 450 nm at an optical path length of 10 mm.

In Japanese National Phase Publication (JP-B) No. WO13/105163, an ultraviolet ray-curable adhesive has been proposed which contains an organic compound that is dissolved in the ultraviolet ray-curable adhesive, that absorbs ultraviolet rays and emits, and that has a maximum wavelength in a range of from 250 to 400 nm in the absorption spectrum and a maximum wavelength in a range of from 350 to 430 nm in the emission spectrum as measured in tetrahydrofuran, a photopolymerizable compound, and a photopolymerization initiator, as an ultraviolet ray-curable adhesive that can be sufficiently cured at a light shielding area even when a light shielding part is created on an optical substrate.

### SUMMARY OF INVENTION

### Technical Problem

However, according to the studies by the inventors, the compositions proposed so far have the following problems.

The active energy ray-curable compositions described in JP-A No. H05-097963, JP-A No. H07-109333, JP-A No. H07-224132, and JP-A No. H07-224133 are so-called “dual-cure” compositions, in which cross-linking proceeds with moisture in the air. However, curing with moisture has a low reaction rate, and the advantage of rapid curing, which is a feature of active energy ray-curable compositions, is greatly impaired. Furthermore, there is also a problem that humidity has a great influence on curing and, if humidity is low, curing failure occurs, and final performance such as insulation reliability and hardness deteriorates.

The active energy ray-curable composition described in JP-A No. H08-287890 improves insulation reliability of the gap compared to conventional ultraviolet ray-curable compositions. However, the dark part curability is completely insufficient.

The active energy ray-curable composition described in JP-A No. H11-050014 can be used only in a limited process of affixing an adherent after irradiation with active energy rays, and the application is limited.

The active energy ray-curable composition described in JP-A No. 2000-169821 includes an onium salt that generates a strong acid, so there is a problem that it easily corrodes metals. In addition, it takes a long time to be completely cured, and the advantage of rapid curing is greatly impaired.

The active energy ray-curable composition described in JP-A No. 2012-219180 is a two-component type, has poor workability, and can be used only in a limited process, and the application is limited.

The active energy ray-curable compositions described in JP-A No. 2015-117265, JP-A No. 2017-145293, and JP-B No. WO13/105163 are inventions characterized by dark part curability. According to the studies by the inventors, as a result of using a black substrate with low light reflectance as an adherend, the dark part curability was completely insufficient.

One embodiment of the present invention has been made in view of the aforementioned problems, and aims to provide an active energy ray-curable composition that is excellent in dark part curability, and particularly has high dark part curability even when a substrate with low light reflectance is used.

### Solution to Problem

As a result of various studies, the present inventors found that an active energy ray-curable composition including a compound having an ethylenically unsaturated group, a fluorescent agent, and a reducing agent at specific ratios is excellent in dark part curability, and have completed the present invention.

The present invention includes the following aspects.
<1> An active energy ray-curable composition, including Component (A), Component (B), and Component (C) below,
in which the active energy ray-curable composition includes Component (B) at a ratio of from 0.001 to 5 parts by weight and Component (C) at a ratio of from 0.1 to 20 parts by weight, each with respect to a total of 100 parts by weight of Component (A):
Component (A): a compound having an ethylenically unsaturated group, in which the compound is not a compound that has a linear or branched saturated hydrocarbon group having 1 to 7 carbon atoms without a substituent and that has one (meth)acryloyl group,
Component (B): a fluorescent agent, and
Component (C): a reducing agent.
<2> The active energy ray-curable composition according to <1>, in which Component (B) includes a compound that emits visible light with a maximum at a wavelength of from 400 to 500 nm.
<3> The active energy ray-curable composition according to <1> or <2>, in which Component (C) includes a thiol compound.
<4> The active energy ray-curable composition according to any one of <1> to <3>, in which Component (C) includes a divalent tin compound.
<5> The active energy ray-curable composition according to any one of <1> to <4>, in which Component (C) includes a trivalent phosphorus compound.
<6> The active energy ray-curable composition according to any one of <1> to <5>, further including a photoradical polymerization initiator as Component (D), in which the active energy ray-curable composition includes Component (D) at a ratio of from 0.01 to 15 parts by weight with respect to a total of 100 parts by weight of Component (A).
<7> The active energy ray-curable composition according to <6>, in which Component (D) has an absorption coefficient at 405 nm of 100 or more.
<8> An active energy ray-curable composition with dark part curability, including the composition according to any one of <1> to <7>.
<9> A substrate, including a cured product of the active energy ray-curable composition with dark part curability according to <8>, in which the cured product is formed on a surface of a substrate having a dark part.
<10> A layered body, including a substrate having no dark part, a cured product of the active energy ray-curable composition with dark part curability according to <8>, and a substrate having a dark part.
<11> A method of manufacturing a substrate having a cured product, including applying the active energy ray-curable composition with dark part curability according to <8>, to a substrate having a dark part, followed by irradiating an active energy ray from a side of a part to which the composition was applied.
<12> A method of manufacturing a layered body having a dark part, sequentially including Step 1 and Step 2 below:
Step 1: applying the active energy ray-curable composition with dark part curability according to <8> to a substrate having no dark part, and affixing a side of the substrate having no dark part at which the active energy ray-curable composition is applied to a substrate having a dark part, or applying the active energy ray-curable composition with dark part curability according to <8> to a substrate having a dark part, and affixing a side of the substrate having a dark part at which the active energy ray-curable composition is applied to a substrate having no dark part, and
Step 2: after Step 1, irradiating an active energy ray from a side of the substrate having no dark part or from a side of the substrate having a dark part.

### Advantageous Effects of Invention

According to one embodiment of the present invention, an active energy ray-curable composition that is excellent in dark part curability, and is particularly excellent in dark part curability when using a substrate with low light reflectance is provided.

Therefore, according to one embodiment of the present invention, an active energy ray-curable composition is provided which can be preferably used as an adhesive, a sealant, a coating agent, or the like, which is used for adherends having a three-dimensional shape that tends to create a dark part such as colored plastics with low light reflectance, plastics and metals that are colored with paint with low light reflectance, and electronic parts.

### BRIEF DESCRIPTION OF DRAWINGS

FIG. 1 schematically shows a top view of a specimen used in the dark part curability test.

FIG. 2 schematically shows a side view of a specimen used in the dark part curability test.

### DESCRIPTION OF EMBODIMENTS

Hereinafter, embodiments of the present invention will be described in detail.

In the present disclosure, “(from) a to b” representing a numerical range means “a or more and b or less”, unless otherwise specified.

In the numerical ranges described stepwise in the present disclosure, the upper limit or lower limit described in a certain numerical range may be replaced with the upper limit or lower limit of another numerical range described stepwise. In addition, in the numerical ranges described in the present disclosure, the upper limit or lower limit described in a certain numerical range may be replaced with the value shown in Examples.

In addition, in the present disclosure, a combination of two or more preferred aspects is a more preferred aspect.

In the present disclosure, when multiple substances corresponding to each component are present, the content of each component means a total content of multiple substances, unless otherwise specified.

The active energy ray-curable composition of the present disclosure (hereinafter, also referred to as the “composition of the present disclosure”) includes Component (A), Component (B), and Component (C) below,
in which the active energy ray-curable composition includes Component (B) at a ratio of from 0.001 to 5 parts by weight and Component (C) at a ratio of from 0.1 to 20 parts by weight, each with respect to a total of 100 parts by weight of Component (A):
Component (A): a compound having an ethylenically unsaturated group, in which the compound is not a compound that has a linear or branched saturated hydrocarbon group having 1 to 7 carbon atoms without a substituent and that has one (meth)acryloyl group,
Component (B): a fluorescent agent, and
Component (C): a reducing agent.
Components (A) to (C) that are the essential components of the composition of the present disclosure, and Component (D) and other components that are formulated as necessary are described below.

### 1. Component (A)

Component (A) is a compound having an ethylenically unsaturated group, in which the compound is not a compound [hereinafter, referred to as “Component (AX)”] that has a saturated hydrocarbon group having 1 to 7 carbon atoms without a substituent and that has one (meth)acryloyl group.

Examples of ethylenically unsaturated groups include a (meth)acryloyl group, a (meth)acrylamide group, a vinyl group and a (meth)allyl group and, because the composition becomes excellent in curability, a (meth)acryloyl group is preferred and an acryloyl group is more preferred.

Component (A) may be a compound having one or more ethylenically unsaturated groups, and specific examples thereof include compounds having one ethylenically unsaturated group (hereinafter, referred to as “monofunctional unsaturated compounds”) and compounds having two or more ethylenically unsaturated groups (hereinafter, referred to as “polyfunctional unsaturated compounds”).

### 1-1. Monofunctional Unsaturated Compound

In Component (A), specific examples of monofunctional unsaturated compounds include compounds having one (meth)acryloyl group (hereinafter, referred to as “monofunctional (meth)acrylates”), (meth)acrylamides having one (meth)acryloyl group (hereinafter, referred to as “monofunctional (meth)acrylamides”), compounds having one vinyl group, and compounds having one allyl group.

However, Component (A) does not encompass, as a monofunctional unsaturated compound, Component (AX), that is, a compound that has a linear or branched saturated hydrocarbon group having 1 to 7 carbon atoms without a substituent and has one (meth)acryloyl group.

Component (AX) has low radical polymerizability in the air, so when used for an active energy ray-curable composition, it tends to remain in a cured product as an unreacted monomer even after curing. Since the compound has a low molecular weight and a low boiling point, defects arise, such as odor becoming problematic and stickiness remaining on a surface of a cured film, which is undesirable.

Specific examples of monofunctional (meth)acrylates include:
alkyl (meth)acrylates having a hydrocarbon group having 8 or more carbon atoms such as octyl (meth)acrylate, isooctyl (meth)acrylate, 2-ethylhexyl (meth)acrylate, nonyl (meth)acrylate, isononyl (meth)acrylate, lauryl (meth)acrylate, and stearyl (meth)acrylate;
mono(meth)acrylates of polyols such as trimethylolpropane mono(meth)acrylate, glycerin mono(meth)acrylate, pentaerythritol mono(meth)acrylate, ditrimethylolpropane mono(meth)acrylate, and dipentaerythritol mono(meth)acrylate;
monofunctional (meth)acrylates having an alicyclic group such as isobornyl (meth)acrylate, dicyclopentanyl (meth)acrylate, dicyclopentenyl (meth)acrylate, dicyclopentanyloxyethyl (meth)acrylate, tert-butylcyclohexyl (meth)acrylate, tricyclodecane methylol (meth)acrylate, and dicyclopentenyloxyethyl (meth)acrylate;
monofunctional (meth)acrylates having an aromatic group such as phenyl (meth)acrylate, benzyl (meth)acrylate, phenoxyethyl (meth)acrylate, o-phenylphenol (meth)acrylate, a (meth)acrylate of an alkylene oxide adduct of phenol, a (meth)acrylate of an alkylene oxide adduct of an alkylphenol, a (meth)acrylate of an alkylene oxide adduct of p-cumylphenol, and a (meth)acrylate of an alkylene oxide adduct of o-phenylphenol; and
alkyl carbitol (meth)acrylates such as a carbitol (meth)acrylates such as ethyl carbitol (meth)acrylate, butyl carbitol (meth)acrylate, and 2-ethylhexyl carbitol (meth)acrylate.

The monofunctional (meth)acrylate may be a compound having various functional groups. Examples of functional groups include a hydroxyl group, a carboxyl group, a cyclic ether group, and a heterocyclic ring.

Examples of monofunctional (meth)acrylates having a hydroxyl group include (meth)acrylates having a hydroxyl group such as 2-hydroxyethyl (meth)acrylate, 2-hydroxypropyl (meth)acrylate, and 4-hydroxybutyl (meth)acrylate, and 2-hydroxy-3-phenoxypropyl (meth)acrylate.

Examples of monofunctional (meth)acrylates having a carboxyl group include (meth)acrylic acid, a michael addition-type dimer of (meth)acrylic acid, ω-carboxy-polycaprolactone mono(meth)acrylate, and phthalate monohydroxyethyl (meth)acrylate.

Examples of compounds having a cyclic ether group include glycidyl (meth)acrylate, tetrahydrofurfuryl (meth)acrylate, (2-methyl-2-ethyl-1,3-dioxolan-4-yl)methyl (meth)acrylate, cyclohexane spiro-2-(1,3-dioxolan-4-yl)methyl (meth)acrylate, and 3-ethyl-3-oxetanylmethyl (meth)acrylate.

Examples of monofunctional (meth)acrylates having a heterocyclic ring include (meth)acryloylmorpholine, and monofunctional (meth)acrylates having an imide group such as N-(2-(meth)acryloxyethyl)hexahydrophthalimide and N-(2-(meth)acryloxyethyl)tetrahydrophthalimide.

Among the aforementioned compounds, there are examples of monofunctional (meth)acrylates having a saturated hydrocarbon group having 1 to 7 carbon atoms. However, these compounds have a substituent on the saturated hydrocarbon group, so there are no such problems as with the case of using Component (AX).

Specific examples of monofunctional (meth)acrylamides include:
N-alkyl (meth)acrylamides such as N,N-dimethyl (meth)acrylamide, (meth)acryloylmorpholine, N-methyl (meth)acrylamide, N-n-propyl (meth)acrylamide, N-isopropyl (meth)acrylamide, N-n-butyl (meth)acrylamide, N-sec-butyl (meth)acrylamide, N-t-butyl (meth)acrylamide, and N-n-hexyl (meth)acrylamide;
N-hydroxyalkyl (meth)acrylamides such as N-hydroxyethyl (meth)acrylamide; and
N,N-dialkyl (meth)acrylamides such as N,N-dimethylaminoethyl (meth)acrylamide, N,N-dimethylaminopropyl (meth)acrylamide, N,N-dimethyl (meth)acrylamide, N,N-diethyl (meth)acrylamide, N,N-di-n-propyl (meth)acrylamide, N,N-diisopropyl (meth)acrylamide, N,N-di-n-butyl (meth)acrylamide and N,N-dihexyl (meth)acrylamide.

Specific examples of compounds having one vinyl group include vinyl monomers such as styrene, vinyl toluene, N-vinylpyrrolidone, N-vinylcaprolactam, vinylimidazole, vinylpyridine, n-propyl vinyl ether, isopropyl vinyl ether, n-butyl vinyl ether, 2-hydroxyethyl vinyl ether, cyclohexanedimethanol monovinyl ether, diethylene glycol monovinyl ether, 4-hydroxybutyl vinyl ether, cyclohexyl vinyl ether, dodecyl vinyl ether, octadecyl vinyl ether, lauryl vinyl ether, cetyl vinyl ether, and 2-ethylhexyl vinyl ether.

Specific examples of compounds having one allyl group include allyl alcohol.

### 1-2. Polyfunctional Unsaturated Compound

Examples of polyfunctional unsaturated compounds include compounds having two (meth)acryloyl groups [hereinafter, referred to as “difunctional (meth)acrylates”] and compounds having three or more (meth)acryloyl groups [hereinafter, referred to as “tri- or higher functional (meth)acrylates”].

Specific examples of difunctional (meth)acrylates include:
aliphatic diol di(meth)acrylates such as ethylene glycol di(meth)acrylate, propylene glycol di(meth)acrylate, 1,4-butanediol diacrylate, 1,6-hexanediol diacrylate, neopentyl glycol diacrylate, 3-methyl-1,5-pentanediol diacrylate, 2-butyl-2-ethyl-1,3-propanediol diacrylate, and 1,9-nonanediol diacrylate;
di(meth)acrylates of tri- or higher hydric polyols such as glycerin di(meth)acrylate, trimethylolpropane di(meth)acrylate, ditrimethylolpropane di(meth)acrylate, pentaerythritol di(meth)acrylate, and dipentaerythritol di(meth)acrylate;
di(meth)acrylates of alkylene oxide adducts of these polyols;
di(meth)acrylates having an isocyanuric acid skeleton such as a di(meth)acrylate of an ethylene oxide adduct of isocyanuric acid; and
di(meth)acrylates of alkylene oxide adducts of bisphenol such as a di(meth)acrylate of an alkylene oxide adduct of bisphenol A and a di(meth)acrylate of an alkylene oxide adduct of bisphenol F.

In this case, examples of the alkylene oxide in the alkylene oxide adduct include ethylene oxide, propylene oxide, tetramethylene oxide, and a combination of ethylene oxide and propylene oxide.

Examples of tri- or higher functional (meth)acrylates include:
polyol poly(meth)acrylates such as glycerin tri(meth)acrylate, trimethylolpropane tri(meth)acrylate, triethanolamine tri(meth)acrylate, a tri- or tetra(meth)acrylate of pentaerythritol, a mixture of tri- and tetraacrylates of pentaerythritol, a tri- or tetra(meth)acrylate of ditrimethylolpropane, a tri- or tetra(meth)acrylate of diglycerin, and a tri-, tetra-, penta- or hexa(meth)acrylate of dipentaerythritol;
tri-, tetra-, penta- or hexa(meth)acrylates of alkylene oxide adducts of these polyols; and
tri(meth)acrylates having an isocyanuric acid skeleton such as a tri(meth)acrylate of an alkylene oxide adduct of isocyanuric acid.

Examples of the alkylene oxide adduct include an ethylene oxide adduct, a propylene oxide adduct, and an ethylene oxide and propylene oxide adduct.

The difunctional (meth)acrylate and the tri- or higher functional (meth)acrylate can also be used in combination. Examples thereof include a mixture of di- and triacrylates of an ethylene oxide adduct of isocyanuric acid.

Examples of polyfunctional unsaturated compounds include, in addition to the aforementioned difunctional (meth)acrylates and tri- or higher functional (meth)acrylates, urethane (meth)acrylates, epoxy (meth)acrylates, polyester (meth)acrylates, polyether (meth)acrylates, polyfunctional polymers, polyfunctional vinyl compounds, and polyfunctional allyl compounds.

These compounds are described below.

### 1-2-1. Urethane (Meth)acrylate

A urethane (meth)acrylate is a (meth)acrylate compound having a urethane bond.

Examples of urethane (meth)acrylates include a reaction product of a polyol, an organic polyisocyanate, and a hydroxyl group-containing (meth)acrylate [hereinafter, referred to as “urethane (meth)acrylate oligomer”] and a reaction product of an organic polyisocyanate and a hydroxyl group-containing (meth)acrylate [hereinafter, referred to as “urethane adduct”].

The raw material compounds and the production method of urethane (meth)acrylates are described below.

### Raw Material Compound

In the case of a urethane (meth)acrylate oligomer, a polyol, an organic polyisocyanate, and a hydroxyl group-containing (meth)acrylate are used as the raw material compounds of the urethane (meth)acrylate. In the case of a urethane adduct, an organic polyisocyanate and a hydroxyl group-containing (meth)acrylate are used.

Specific examples of polyols include polyether polyols, polycarbonate polyols, polyester polyols, and diols having a polyene skeleton.

Examples of polyether polyols include polyalkylene glycols having two or more oxyalkylene units, specific examples of which include polyethylene glycol, polypropylene glycol, and polytetramethylene glycol.

Examples of polycarbonate polyols include reaction products of carbonates and diols. Specific examples of carbonates include diaryl carbonates such as diphenyl carbonate, and dialkyl carbonates such as dimethyl carbonate and diethyl carbonate. Examples of diols include ethylene glycol, propylene glycol, butanediol, 1,6-hexanediol, 2-methyl-1,8-octanediol, nonanediol, cyclohexanedimethanol, neopentyl glycol, 3-methyl-1,5-pentanediol and neopentylglycol hydroxypivalic acid ester (hereinafter, referred to as “low molecular weight diol”).

Examples of polyester polyols include reaction products of acid components and at least one selected from the group consisting of the aforementioned low molecular weight diols, polyether polyols, and polycarbonate polyols. Specific examples of acid components include dibasic acids such as adipic acid, sebacic acid, succinic acid, maleic acid, phthalic acid, hexahydrophthalic acid and terephthalic acid, or anhydrides thereof, and ring-opening reaction products of polycarbonate diols and caprolactones.

Examples of diols having a polyene skeleton include diols having a polybutadiene skeleton, diols having a polyisoprene skeleton, diols having a hydrogenated polybutadiene skeleton, and diols having a hydrogenated polyisoprene skeleton.

The aforementioned polyols may be used singly or in combination of two or more.

Examples of organic polyisocyanates include diisocyanates and triisocyanates.

Specific examples of diisocyanates include aromatic diisocyanates such as tolylene diisocyanate, 4,4′-diphenylmethane diisocyanate, xylene diisocyanate, and naphthalene diisocyanate, aliphatic diisocyanates such as hexamethylene diisocyanate and trimethylhexamethylene diisocyanate, and alicyclic diisocyanates such as isophorone diisocyanate, 4,4′-dicyclohexylmethane diisocyanate, norbornene diisocyanate, and a hydrogenated xylene diisocyanate.

Specific examples of diisocyanates include 1,6,11-undecane triisocyanate, 1,3,6-hexamethylene triisocyanate, and bicycloheptane triisocyanate.

The aforementioned organic polyisocyanates may be used singly or in combination of two or more.

Specific examples of hydroxyl group-containing (meth)acrylates include:
hydroxyl group-containing monofunctional (meth)acrylates such as 2-hydroxyethyl (meth)acrylate, 2-hydroxypropyl (meth)acrylate, 2-hydroxybutyl (meth)acrylate, 4-hydroxybutyl (meth)acrylate, 1,4-cyclohexanedimethylol mono(meth)acrylate, pentanedial mono(meth)acrylate, hexanediol mono(meth)acrylate, diethylene glycol mono(meth)acrylate, triethylene glycol mono(meth)acrylate, tetraethylene glycol mono(meth)acrylate, polyethylene glycol mono(meth)acrylate, dipropylene glycol mono(meth)acrylate, tripropylene glycol mono(meth)acrylate, polypropylene glycol mono(meth)acrylate, 2-hydroxy-3-phenoxypropyl (meth)acrylate, and 2-hydroxy-3-butoxypropyl (meth)acrylate; and
hydroxyl group-containing polyfunctional (meth)acrylates such as a mono- or di(meth)acrylate of trimethylolpropane, a mono-, di- or tri(meth)acrylate of pentaerythritol, a mono-, di- or tri(meth)acrylate of ditrimethylolpropane, a mono-, di-, tri-, tetra-, or penta(meth)acrylate of dipentaerythritol, and epoxy(meth)acrylate.

The aforementioned hydroxyl group-containing (meth)acrylates may be used singly or in combination of two or more.

### Production Method

Among the urethane (meth)acrylates, the urethane (meth)acrylate oligomer can be produced by heating and stirring a polyol, an organic polyisocyanate, and a hydroxyl group-containing (meth)acrylate in the presence of a urethanization catalyst and, if necessary, in the presence of a reaction solvent, to perform urethanization.

In this case, the polyol, the organic polyisocyanate, and the hydroxyl group-containing (meth)acrylate can be charged together and reacted (hereinafter, referred to as “one-step reaction”), or the polyol and the organic polyisocyanate can be reacted to form an isocyanate group-containing prepolymer, followed by adding the hydroxyl group-containing (meth)acrylate (hereinafter, referred to as “two-step reaction”).

The urethane adduct can be produced by heating and stirring in the presence of an organic polyisocyanate, a hydroxyl group-containing (meth)acrylate, and a urethanization catalyst and, if necessary, in the presence of a reaction solvent, to perform urethanization.

Examples of the urethanization catalyst include amine compounds and metal catalysts.

Specific examples of amine compounds include triethylamine.

Specific examples of metal catalysts include dibutyltin dilaurate, dibutyltin diacetate, dibutyltin dioctate, dibutyltin diacetylacetonate, bismuth dioctate, iron (III) acetylacetonate, zinc acetylacetonate, and aluminum acetylacetonate.

The aforementioned urethanization catalysts may be used singly or in combination of two or more.

In the case of the urethane (meth)acrylate oligomer, the ratio of the polyol and the organic polyisocyanate may be appropriately set according to the structure of the urethane (meth)acrylate to be finally obtained. Specifically, the total amount of isocyanate groups in the organic polyisocyanate is preferably from 1.05 to 2 mol with respect to the total amount of 1 mol of hydroxyl groups in the polyol.

It is preferable that the ratio of the hydroxyl group-containing (meth)acrylate is a ratio such that no isocyanate group remains in the resulting urethane (meth)acrylate.

In the case of producing by the aforementioned two-step reaction, the total amount of hydroxyl groups in the hydroxyl group-containing (meth)acrylate is preferably from 1.0 to 1.5 mol with respect to the total amount of 1 mol of isocyanate groups in the isocyanate group-containing prepolymer.

In the case of producing by the aforementioned one-step reaction, the total amount of hydroxyl groups in the hydroxyl group-containing (meth)acrylate is preferably from 1.0 to 1.5 mol with respect to the total amount of l mol of isocyanate groups that remain in the isocyanate group-containing prepolymer as calculated based on the structure of the urethane (meth)acrylate to be finally obtained.

In this case, the total amount of hydroxyl groups in the polyol and the hydroxyl group-containing (meth)acrylate is preferably from 1.0 to 1.5 mol with respect to the total amount of 1 mol of isocyanate groups in the organic polyisocyanate.

In the case of the urethane adduct, it is preferable that the ratio of the hydroxyl group-containing (meth)acrylate is a ratio such that no isocyanate group remains in the resulting urethane (meth)acrylate. The total amount of hydroxyl groups in the hydroxyl group-containing (meth)acrylate is preferably from 1.0 to 1.5 mol with respect to the total amount of 1 mol of isocyanate groups in the organic polyisocyanate.

If the molecular weight of the urethane (meth)acrylate produced by the reaction increases, the reaction mixture may become highly viscous and stirring may become difficult. Therefore, a reaction solvent can be added to the reaction components.

The reaction solvent is preferably a solvent that does not participate in the urethanization reaction, and examples thereof include organic solvents such as aromatic-based solvents toluene, xylene, etc.) and ketone-based solvents (methyl ethyl ketone, methyl isobutyl ketone, etc.).

When using an organic solvent, the formulation amount thereof may be appropriately set according to the viscosity of the urethane (meth)acrylate to be produced or the like, and is preferably set to be from 0 to 70% by weight in the reaction solution.

When only raw material compounds are used, the reaction solution means the total amount of the raw material compounds. When a reaction solvent or the like is used in addition to raw material compounds, the reaction solution means the total amount including them. Specifically, it is used to mean a solution obtained by formulating a polyol, an organic polyisocyanate, a hydroxyl group-containing (meth)acrylate, and a reaction solvent or the like used as necessary.

As the reaction solvent, a (meth)acrylate compound (hereinafter, referred to as “other (meth)acrylate”) other than the urethane (meth)acrylate that may be used as a component of the composition can be formulated together with or in place of the aforementioned organic solvent. As other (meth)acrylate, those described as other components to be described later can be used. In addition, formulating other (meth)acrylate to perform a urethanization reaction and formulating the resulting urethane (meth)acrylate in the composition is preferable, because it is not necessary to dry the composition after applying it unlike the case of formulating the organic solvent.

In the case in which other (meth)acrylate is formulated in the reaction components, the formulation amount thereof may be appropriately set according to the ratio of other (meth)acrylate to be finally formulated in the composition, and is preferably set to be from 10 to 70% by weight and more preferably from 10 to 50% by weight in the reaction solution.

The amount of the urethanization catalyst may be a catalytic amount. For example, the amount is preferably from 0.01 to 1,000 wtppm and more preferably from 0.1 to 1,000 wtppm, with respect to the total weight of the reaction solution. By setting the amount of the metal compound to be 0.01 wtppm or more, the urethanization reaction can proceed favorably, and by setting the amount of the metal compound to be 1,000 wtppm or less, it is possible to suppress coloring of the resulting urethane (meth)acrylate.

In the case of the urethane (meth)acrylate oligomer, the urethanization catalyst can be added at the time of charging the polyol, the organic polyisocyanate, and the hydroxyl group-containing (meth)acrylate for the one-step reaction, and can be added at the time of charging the polyol and the organic polyisocyanate for the two-step reaction.

In the case of the urethane adduct, the urethanization catalyst can be added at the time of charging the organic polyisocyanate and the hydroxyl group-containing (meth)acrylate.

In the urethanization reaction, a small amount of a chain extender can be formulated for the purpose of molecular weight adjustment.

As the chain extender, those commonly used in the urethanization reaction can be used, and examples thereof include those that are the same as the aforementioned low molecular weight polyols.

In the urethanization reaction, a polymerization inhibitor is preferably used and, in addition, an oxygen-containing gas may be introduced into the reaction solution, for the purpose of preventing polymerization of the (meth)acryloyl group of the raw material or the product.

Specific examples of polymerization inhibitors include organic polymerization inhibitors such as hydroquinone, tert-butylhydroquinone, hydroquinone monomethyl ether, 2,6-di-tert-butyl-4-methylphenol, 2,4,6-tri-tert-butylphenol, benzoquinone, and phenothiazine, inorganic polymerization inhibitors such as copper chloride and copper sulfate, organic salt polymerization inhibitors such as copper dibutyldithiocarbamate, and stable radicals such as 4-hydroxy-2,2,6,6-tetramethylpiperidine-1-oxyl free radical and galvinoxyl.

The polymerization inhibitors may be used singly or in any combination of two or more. The ratio of the polymerization inhibitor is preferably from 5 to 20,000 wtppm and more preferably from 25 to 3,000 wtppm, with respect to the total weight of the reaction solution.

Examples of oxygen-containing gases include air, a mixed gas of oxygen and nitrogen, and a mixed gas of oxygen and helium.

The reaction temperature may be appropriately set according to the structure, molecular weight, or the like, of the raw materials used and the target urethane (meth)acrylate, and is usually preferably from 25 to 150° C. and more preferably from 30 to 120° C. The reaction time may also be appropriately set according to the structure, molecular weight, or the like, of the raw materials used and the target urethane (meth)acrylate, and is usually preferably from 1 to 70 hours and more preferably from 2 to 30 hours.

The weight average molecular weight (hereinafter, referred to as “Mw”) of the urethane (meth)acrylate in the present disclosure is preferably from 500 to 50,000 from the viewpoint of improving the adhesive strength of the composition.

In the present disclosure, the Mw is a value determined by converting a molecular weight measured by gel permeation chromatography (hereinafter, referred to as “GPC”) in terms of polystyrene, and means a value measured under the following conditions:
Detector: differential refractometer (RI (Refractive Index) detector)
Column type: crosslinked polystyrene column
Column temperature: 40° C.
Eluent: Tetrahydrofuran
Molecular weight standard substance: polystyrene

Examples of urethane (meth)acrylates other than those described above include compounds described on pages 70 to 74 of the document “UV⋅EB Curing Materials” [CMC Co., Ltd., published in 1992].

### 1-2-2. Epoxy (Meth)acrylate

An epoxy (meth)acrylate is a compound obtained by addition reaction of (meth)acrylic acid to an epoxy resin, and examples thereof include the compounds described on pages 74 to 75 of the aforementioned document “UV⋅EB Curing Materials”.

Examples of epoxy resins include aromatic epoxy resins and aliphatic epoxy resins.

Specific examples of aromatic epoxy resins include resorcinol diglycidyl ether; di- or polyglycidyl ethers of bisphenol A, bisphenol F, bisphenol S, bisphenol fluorene, or an alkylene oxide adduct thereof; novolak type epoxy resins such as a phenol novolak type epoxy resin and a cresol novolak type epoxy resin; glycidyl phthalimide; and o-diglycidyl phthalate.

In addition to these, examples include the compounds described in chapter 2 of the document “Epoxy Resin—Recent Progress—” (Shokodo, published in 1990), and the compounds descried on pages 4 to 6 and pages 9 to 16 of the document “Polymer Processing” Separate Volume 9, Volume 22 Extra Edition Epoxy Resin [Kobunshi publication society, published in 1973].

Specific examples of aliphatic epoxy resins include diglycidyl ethers of alkylene glycols such as ethylene glycol, propylene glycol, 1,4-butanediol and 1,6-hexanediol; diglycidyl ethers of polyethylene glycols such as a diglycidyl ether of polyethylene glycol or polypropylene glycol; a diglycidyl ether of neopentyl glycol, dibromoneopentyl glycol, or an alkylene oxide adduct thereof; polyglycidyl ethers of polyhydric alcohols such as a di- or triglycidyl ether of trimethylolethane, trimethylolpropane, glycerin, or an alkylene oxide adduct thereof; and a di-, tri- or tetraglycidyl ether of pentaerythritol or an alkylene oxide adduct thereof; a di- or polyglycidyl ether of a hydrogenated bisphenol A or an alkylene oxide adduct thereof; tetrahydrophthalic acid diglycidyl ether; and hydroquinone diglycidyl ether.

In addition to these, examples include the compounds described on pages 3 to 6 of the aforementioned document “Polymer Processing” Separate Volume Epoxy Resin.

In addition to these aromatic epoxy resins and aliphatic epoxy resins, examples include epoxy compounds having a triazine nucleus in the skeleton such as TEPIC [Nissan Chemical Co., Ltd.] and Denacol EX-310 [Nagase Kasei Co., Ltd.], as well as the compounds described on pages 289 to 296 of the aforementioned document “Polymer Processing” Separate Volume Epoxy Resin.

In the above, the alkylene oxide of the alkylene oxide adduct is preferably ethylene oxide, propylene oxide, or the like.

In addition to those described above, examples include the compounds described on pages 53 to 56 of the document “Latest UV Curing Technology” [Printing Information Association, published in 1991].

### 1-2-3. Polyester (Meth)acrylate

Examples of polyester (meth)acrylates include dehydration condensates of polyester polyols and (meth)acrylic acid.

Here, examples of polyester polyols include compounds that are the same as those exemplified in item 1-2-1 described above.

Further, as polyester polyols, a polyester diol is preferable, and examples thereof include a reaction product of a diol, and a dicarboxylic acid or its anhydride. Specific examples thereof include compounds that are the same as those described above.

### 1-2-4. Polyether (Meth)acrylate Oligomer

Examples of polyether (meth)acrylate oligomers include polyalkylene glycol di(meth)acrylates, specific examples of which include polyethylene glycol di(meth)acrylate, polypropylene glycol di(meth)acrylate, and polytetramethylene glycol di(meth)acrylate.

### 1-2-5. Polyfunctional Unsaturated Compounds Other Than Those Described Above

Examples of polyfunctional polymers include (meth)acrylic polymers having a (meth)acryloyloxy group and (meth)acrylic polymers having a functional group in which a (meth)acryloyl group is introduced into the side chain, and examples include the compounds described on pages 78 to 79 of the aforementioned document “UV⋅EB Curing Materials”.

Examples of polyfunctional vinyl compounds include compounds having two or more vinyl groups, Specific examples include divinylbenzene, 1,4-butanediol divinyl ether, cyclohexanedimethanol divinyl ether, diethylene glycol divinyl ether, triethylene glycol divinyl ether, and 2-(2-vinyloxyethoxy)ethyl (meth)acrylate.

Examples of polyfunctional allyl compounds include compounds having two or more allyl groups. Specific examples include diallyl phthalate, triallyl isocyanurate, and triallyl cyanurate.

### 2. Component (B)

Component (B) is a fluorescent agent. A fluorescent agent means a compound having fluorescence performance (photoluminescence) and, in the present disclosure, means a compound that absorbs active energy rays in an ultraviolet region and emits fluorescence in a visible light region.

In Component (B), the wavelength range of active energy rays to be absorbed is preferably from 200 to 450 nm and more preferably from 250 to 430 nm, and the wavelength range of visible light to be emitted is preferably from 350 to 700 nm and more preferably from 380 to 600 nm.

The absorption wavelength of Component (B) means a value determined by using an acetonitrile solution of Component (B) (concentration of from 0.008 to 1% by weight, the concentration is set so that the absorbance becomes 1 or less) and using a spectrophotometer, to measure an absorption spectrum.

The emitted visible light preferably exhibits a maximum at a wavelength of from 400 to 500 nm, more preferably from 430 nm to 500 nm, and even more preferably more than 430 nm but 470 nm or less. Exhibiting a maximum within this range enables excessive absorption of the emitted visible light by Component (B), and Component (D), which is formulated as necessary, to be suppressed, thereby improving dark part curability.

The emission wavelength of Component (B) means a value determined by using a tetrahydrofuran solution of Component (B) (concentration of 0.002% by weight) and using a spectrafluorophotometer, to measure an emission spectrum at an excitation light wavelength of 365 nm.

Fluorescent brighteners are known as compounds that have the aforementioned preferred absorption wavelength and emission wavelength in Component (B). Fluorescent brighteners are preferred as Component (B) because, for example, they are readily available and less hazardous.

Specific examples of fluorescent brighteners include thiophene-based fluorescent brighteners, coumarin-based fluorescent brighteners, stilbene-based fluorescent brighteners, naphthalene-based fluorescent brighteners, and benzimidazole-based fluorescent brighteners.

Examples of thiophene-based fluorescent brighteners include 2,5-bis(5-t-butyl-2-benzoxazolyl)thiophene, 2,5-bis(benzoxazol-2-yl)thiophene, 2,5-bis(benzoxazol-2-yl)thiophene, and 2,5-thiophenediylbis(5-tert-butyl-1,3-benzoxazole).

Thiophene-based fluorescent brighteners are commercially available, and commercially available products can be used. Examples thereof include Tinopal OB [manufactured by BASF Japan] and NIKKAFLUOR OB [manufactured by Nippon Kagaku Kogyo Ltd.].

Examples of coumarin-based fluorescent brighteners include 4-methyl-7-hydroxycoumarin, 4-methyl-7-diethylaminocoumarin, 4-methyl-7-aminocoumarin, 4-methyl-7-pyrrolidinylcoumarin, 4-methyl-7-(3′,5′-diphenyl-4′,5′-hydropyrazolyl)coumarin, 4-methyl-3-(4′-cyanophenyl)-7-(3′,5′- dimethylpyrazolyl)coumarin, 4-methyl-3-(4′-ethoxycarbonylphenyl)-7-(3′,5′-dimethylpyrazolyl)coumarin, 3-(4′-carbonylphenyl)-4-methyl-7-diethylaminocoumarin, 3-(4′-acetylaminophenyl)-4-methyl-7-diethylaminocoumarin, 3-phenyl-7-(3′-methylpyrazolyl)coumarin, 3-(4′-acetylaminophenyl)-7-acetylaminocoumarin, 7-amino-3,4-benzocoumarin, and 7-acetylamino-3,4-benzocoumarin.

Coumarin-based fluorescent brighteners are commercially available, and commercially available products can be used. Examples thereof include NIKKAFLUOR MC-T [manufactured by Nippon Kagaku Kogyo Co., Ltd.], Kayalight B [manufactured by Nippon Kayaku Co., Ltd.], and Hakkol P [manufactured by Showa Chemical Industry Co., Ltd.].

Examples of stilbene-based fluorescent brighteners include 4,4′-bis(2-benzoxazolyl)stilbene, sodium 4-(2H-naphtho[1,2-d]triazol-2-yl)stilbene-2-sulfonate, disodium 4,4′-bis[(1,4-dihydro-4-oxo-6-phenylamino-1,3,5-triazin-2-yl)amino]stilbene-2,2′-disulfonate, sodium 2,2′-(1,2-ethenediyl)bis[5-(3-phenylureido)benzenesulfonate], sodium 2,2′-(1,2-ethenediyl)bis[5-[(4-amino-6-chloro-1,3,5-triazin-2-yl)amino]benzenesulfonate], disodium 4,4′-bis[[4-anilino-6-[bis(2-hydroxyethyl)amino]-1,3,5-triazin-2-yl]amino]stilbene-2,2′-disulfonate, sodium 2,2′-[1,2-ethenediylbis(3-sodiosulfo-4,1-phenylene)]bis(2H-naphtho[1,2-d]triazole-6-sulfonate), sodium 2,2′-(1,2-ethenediyl)bis[5-[(2,4-dimethoxybenzoyl)amino]benzenesulfonate], disodium 2,2′-(1,2-ethenediyl)bis[5-[[4-methoxy-6-[phenylamino]-1,3,5-triazin-2-yl]amino]benzenesulfonate], sodium 4,4′-bis[(6-amino-1,4-dihydro-oxo-1,3,5-triazin-2-yl)amino]stilbene-2,2′-disulfonate, and disodium 2,2′-([1,1′-biphenyl]-4,4′-diyldivinylene)bis(benzenesulfonate).

Stilbene-based fluorescent brighteners are commercially available, and commercially available products can be used. Examples thereof include stilbene fluorescent brighteners NIKKAFLUOR SB, NIKKAFLUOR RP, and NIKKAFLUOR 2R [each manufactured by Nippon Kagaku Kogyo Co., Ltd.].

Examples of naphthalene-based fluorescent brighteners include 1,4-bis(2-benzoxazolyl)naphthalene.

Naphthalene-based fluorescent brighteners are commercially available, and commercially available products can be used. Examples thereof include NIKKAFLUOR KB [manufactured by Nippon Kagaku Kogyo Co., Ltd.].

Benzimidazole-based fluorescent brighteners are commercially available, and commercially available products can be used. Examples thereof include HOSTALUX ACK LIQ [manufactured by Clariant Japan].

Also, examples of fluorescent agents other than those described above include polycyclic aromatic hydrocarbon compounds. Examples thereof include anthracene compounds and perylene compounds.

Among these as Component (B), thiophene-based fluorescent brighteners, coumarin-based fluorescent brighteners, stilbene-based fluorescent brighteners, naphthalene-based fluorescent brighteners, benzimidazole-based fluorescent brighteners, and perylene compounds are preferred because of excellent dark part curability, storage stability, and solubility. Among these, thiophene-based fluorescent brighteners are more preferred and, specifically, 2,5-thiophenediylbis(5-tert-butyl-1,3-benzoxazole) is preferred.

These compounds can be used singly or in combination of two or more.

The content of Component (B) is from 0.001 to 5 parts by weight, preferably from 0.005 to 1 part by weight, and more preferably from 0.01 to 0.1 parts by weight, with respect to a total of 100 parts by weight of Component (A).

If the content of Component (B) is less than 0.001 parts by weight, the dark part curability cannot be improved. If the content of Component (B) is more than 5 parts by weight, the curability of the bottom of the coating film deteriorates.

### 3. Component (C)

Component (C) is a reducing agent. A reducing agent means an element or a molecule that reduces other chemical species in a redox reaction.

Specific examples of Component (C) include amine compounds, thiourea derivatives, metal salts, organic acid compounds, aldehyde compounds, phenol compounds, phosphorus compounds, and thiol compounds.

Examples of amine compounds include N,N-dimethylaniline, N,N-dimethyl-p-toluidine, N,N-dimethyl-m-toluidine, N,N-diethyl-p-toluidine, N,N-dimethyl-3,5-dimethylaniline, N,N-dimethyl-3,4-dimethylaniline, N,N-dimethyl-4-ethylaniline, N,N-dimethyl-4-i-propylaniline, N,N-dimethyl-4-t-butylaniline, N,N-dimethyl-3,5-di-t-butylaniline, N,N-bis(2-hydroxyethyl)-p-toluidine, N,N-bis(2-hydroxyethyl)-3,5-dimethylaniline, N,N-bis(2-hydroxyethyl)-3,4-dimethylaniline, N,N-bis(2-hydroxyethyl)-4-ethylaniline, N,N-bis(2-hydroxyethyl)-4-i-propylaniline, N,N-bis(2-hydroxyethyl)-4-t-butylaniline, N,N-di(2-hydroxyethyl)-3,5-di-i-propylaniline, N,N-bis(2-hydroxyethyl)-3,5-di-t-butylaniline, ethyl 4-dimethylaminobenzoate, n-butoxyethyl 4-dimethylaminobenzoate, 4-dimethylaminobenzoate(2-methacryloyloxy)ethyl, trimethylamine, triethylamine, tripropylamine, tributylamine, N-methyldiethanolamine, N-ethyldiethanolamine, N-n-butyldiethanolamine, N-lauryldiethanolamine, triethanolamine, (2-dimethylamino)ethyl methacrylate, N,N-bis(methacryloyloxyethyl)-N-methylamine, N,N-bis(methacryloyloxyethyl)-N-ethylamine, N,N-bis(2-hydroxyethyl)-N-methacryloyloxyethylamine, N,N-bis(methacryloyloxyethyl)-N-(2-hydroxyethyl)amine, tris(methacryloyloxyethyl)amine, N,N-dimethylaminoethyl methacrylate, methyl-4-dimethylaminobenzoate, ethyl-4-dimethylaminobenzoate, isoamyl-4-dimethylaminobenzoate, and diethylenetriamine.

Examples of thiourea derivatives include 2-imidazolidinethione, 2-mercaptobenzimidazole, thiourea, methylthiourea, tetramethylthiourea, ethylenethiourea, N,N′-dimethylthiourea, N,N′-diethylthiourea, N,N′-dipropylthiourea, N,N′-di-n-butylthiourea, N,N′-dilaurylthiourea, N,N′-diphenylthiourea, trimethylthiourea, 1-acetyl-2-thiourea, and 1-benzoyl-2-thiourea.

Examples of metal salts include iron (II) acetate, copper (I) acetate, iron (II) formate, copper (I) formate, iron (II) oxalate, copper (I) oxalate, iron (II) stearate, copper (I) stearate, iron (II) bis(2-ethylhexanoate), tin (II) (2-ethylhexanoate), copper (I) bis(2-ethylhexanoate), iron (II) naphthenate, copper (I) naphthenate, cobalt naphthenate, cobalt acetylacetonate, vanadyl (IV) acetylacetonate, vanadyl stearate, vanadium naphthenate, vanadium (III) acetylacetonate, vanadium benzoylacetonate, bis(acetylacetonato)oxovanadium (IV), bis(benzoylacetonato)oxovanadium (IV), bis(stearoyloxy)oxovanadium (IV), vanadyl oxalate, and vanadyl naphthenate.

The vanadium compound may also be a pentavalent vanadium compound, for example, vanadium (V) pentoxide, metavanadic acid (V) salt, or tri(alkoxy)oxovanadium (V). Pentavalent vanadium compounds may form tetravalent vanadium compounds in the composition in the presence of acidic compounds such as phosphoric acid compounds (dibutyl phosphate, tributyl phosphate, etc.).

Examples of organic acid compounds include:
ascorbic acid, and ascorbates such as sodium ascorbate and potassium ascorbate;
erythorbic acid, and erythorbates such as sodium erythorbate and potassium erythorbate; tartaric acid, and tartrates such as sodium tartrate and potassium tartrate;
phosphorous acid, and phosphites such as sodium phosphite and potassium phosphite;
hydrogen phosphites such as sodium hydrogen phosphite and potassium hydrogen phosphite;
sulfites such as sodium sulfite and potassium sulfite;
hydrogen sulfites such as sodium hydrogen sulfite and potassium hydrogen sulfite;
thiosulfates such as sodium thiosulfate and potassium thiosulfate;
thiosulfites such as sodium thiosulfite and potassium thiosulfite;
pyrosulfites such as sodium pyrosulfite and potassium pyrosulfite,
hydrogen pyrosulfite such as sodium hydrogen pyrosulfite and potassium hydrogen pyrosulfite; and
pyrophosphates such as sodium pyrophosphate and potassium pyrophosphate.

In addition to those described above, examples include sodium hydroxymethanesulfonate (sodium formaldehyde sulfoxylate), sodium sulfinate derivatives, propyl formate, isoamyl formate, pentyl formate, and phenyl formate.

Examples of aldehyde compounds include aromatic aldehydes such as benzaldehyde, anisaldehyde, and p-methoxyaldehyde, and aliphatic aldehydes such as propionaldehyde, hexylaldehyde, and glyoxal. An aldimine compound that is a condensate with a primary amine is preferably used as the aldehyde compound.

Examples of phenolic compounds include catechol, resorcinol, p-hydroquinone, pyrocatechol, and catecholamine.

A trivalent compound having reducing property is preferable as the phosphorus compound.

Specific examples of trivalent phosphorus compounds include:
phosphine compounds such as triethylphosphine, tri-n-butylphosphine, tri-n-octylphosphine, tris(3-hydroxypropyl)phosphine, and triphenylphosphine; and
phosphites such as triphenylphosphite, tris(nonylphenyl)phosphite, tricresylphosphite, triethylphosphite, tris(2-ethylhexyl)phosphite, tridecylphosphite, trilaurylphosphite, tris(tridecyl)phosphite, trioleylphosphite, diphenylmono(2-ethylhexyl)phosphite, diphenylmonodecylphosphite, diphenylmono(tridecyl)phosphite, trilauryltrithiophosphite, tetraphenyldipropylene glycol diphosphite, tetra(C12-C15 alkyl)-4,4′-isopropylidenediphenyl diphosphite, 4,4′-butylidenebis(3-methyl-6-t-butylphenylditridecylphosphite), bis(decyl)pentaerythritol diphosphite, tris(2,4-di-tert-butylphenyl)phosphite, isodecyldiphenylphosphite, and triisodecylphosphite.

A thiol compound is a compound containing one or more thiol groups in the molecule, and specific examples include the following.

Examples of compounds having one thiol group in the molecule include n-hexylmercaptan, n-octylmercaptan, n-dodecylmercaptan, and t-dodecylmercaptan.

Examples of compounds having two thiol groups in the molecule include 1,2-ethanedithiol, 1,3-propanedithiol, 1,4-butanedithiol, 2,3-butanedithiol, 1,5-pentanedithiol, 1,6-hexanedithiol, 1,8-octanedithiol, 1,9-nonanedithiol, 2,3-dimercapto-1-propanol, dithioerythritol, 2,3-dimercaptosuccinic acid, 1,2-benzenedithiol, 1,2-benzenedimethanethiol, 1,3-benzenedithiol, 1,3-benzenedimethanethiol, 1,4-benzenedimethanethiol, 3,4-dimercaptotoluene, 4-chloro-1,3-benzenedithiol, 2,4,6-trimethyl-1,3-benzenedimethanethiol, 4,4′-thiodiphenol, 2-hexylamino-4,6-dimercapto-1,3,5-triazine, 2-diethylamino-4,6-dimercapto-1,3,5-triazine, 2-cyclohexylamino-4,6-dimercapto-1,3,5-triazine, 2-di-n-butylamino-4,6-dimercapto-1,3,5-triazine, ethylene glycol bis(3-mercaptopropionate), butanediol bisthioglycolate, ethylene glycol bisthioglycolate, 2,5-dimercapto-1,3,4-thiadiazole, 2,2′-(ethylenedithio)diethanethiol, 2,2-bis(2-hydroxy-3-mercaptopropoxyphenylpropane), and 1,4-bis(3-mercaptobutyryloxy)butane.

Examples of compounds having three thiol groups in the molecule include 1,2,6-hexanetriol trithioglycolate, 1,3,5-trithiocyanuric acid, 1,3,5-tris(3-mercaptobutyryl oxyethyl)-1,3,5-triazine, trimethylolpropane tris(3-mercaptopropionate), trimethylolpropane tris(3-mercaptobutyrate), trimethylolpropane tristhioglycolate, and tris[(3-mercaptopropionyloxy)-ethyl]isocyanurate.

Examples of compounds having four thiol groups in the molecule include pentaerythritol tetrakis(3-mercaptobutyrate), pentaerythritol tetrakis(3-mercaptopropionate), and pentaerythritol tetrakisthioglycolate.

Examples of compounds having live or more thiol groups in the molecule include dipentaerythritol hexakis(3-mercaptopropionate), and a compound obtained by carrying out radical polymerization reaction of a (meth)acrylate monomer having a hydroxy group and a (meth)acrylate monomer, followed by carrying out esterification reaction with a mercapto organic acid.

As Component (C), among these compounds, metal salts, thiol compounds, and phosphorus compounds are preferable because it is possible to improve the dark part curability and, among them, divalent tin compounds, thiol compounds, and trivalent phosphorus compounds are more preferable.

These compounds can be used singly or in combination of two or more.

The content of Component (C) is from 0.1 to 20 parts by weight, preferably from 1 to 15 parts by weight, and more preferably from 5 to 10 parts by weight, with respect to a total of 100 parts by weight of Component (A).

When the content of Component (C) is less than 0.1 parts by weight, the dark part curability is insufficient. When the content of Component (C) is more than 20 parts by weight, the storage stability of the composition is lowered, or the elastic modulus of the cured product is lowered.

### 4. Active Energy Ray-Curable Composition

The active energy ray-curable composition of the present disclosure includes Components (A) to (C) above, in which the active energy ray-curable composition includes Component (B) at a ratio of from 0.001 to 5 parts by weight and Component (C) at a ratio of from 0.1 to 20 parts by weight, each with respect to a total of 100 parts by weight of Component (A).

A composition that includes only Components (A) and (B) but does not include Component (C) has dark part curability, but has insufficient dark part curability in that the composition is cured only in a range of about several millimeters from an end of the dark part. On the other hand, the composition of the present disclosure includes the three components of Components (A), (B) and (C) at the aforementioned ratio, and exhibits excellent dark part curability in that the composition is cured in a range of at least several tens of millimeters from an end of the dark part.

The composition of the present disclosure can be produced by a conventional method and can be produced, for example, by stirring and mixing Components (A) to (C) and, if necessary, other components described later.

The stirring speed, the temperature during stirring, and the like, may be appropriately set according to the composition to be produced, the purpose, and the like.

When stirring and mixing, heating can be performed as necessary. The temperature in this case is preferably from 30 to 100° C. and particularly preferably from 40 to 80° C.

The composition of the present disclosure includes Components (A) to (C) as essential components, but various components can be formulated depending on the purpose.

Specific examples of other components include photoradical polymerization initiators [hereinafter, referred to as “Component (D)”], antioxidants, ultraviolet absorbers, silane coupling agents, surface modifiers, and polymerization inhibitors.

These components are described below.

For other components described later, only one of the exemplified compounds may be used, or two or more may be used in combination.

### 4-1. Component (D)

The composition of the present disclosure includes Components (A) to (C) as essential components, but, in order to further improve the dark part curability, a photoradical polymerization initiator as Component (D) may be formulated.

Component (D) is a compound that generates radicals by irradiation with an active energy ray and initiates polymerization of the compound having an ethylenically unsaturated group as Component (A).

Depending on the kind of Component (D), there are some that act as sensitizers that promote photodecomposition of Component (D).

Specific examples of Component (D) include:
aromatic ketone compounds such as benzyl dimethyl ketal, benzyl, benzoin, benzoin ethyl ether, benzoin isopropyl ether, benzoin isobutyl ether, 1-hydroxycyclohexylphenyl ketone, 2-hydroxy-2-methyl-1-phenylpropane-1-one, 1-[4-(2-hydroxyethoxy)-phenyl]-2-hydroxy-2-methyl-1-propan-1-one, oligo[2-hydroxy-2-methyl-1-[4-1-(methylvinyl)phenyl]propanone, 2-hydroxy-1-{4-[4-(2-hydroxy-2-methyl-propionyl)-benzyl]-phenyl}-2-methylpropan-1-one, 2-methyl-1-[4-(methylthio)]phenyl]-2-morpholinopropan-1-one, 2-benzyl-2-dimethylamino-1-(4-morpholinophenyl)butan-1-one, 2-dimethylamino-2-(4-methylbenzyl)-1-(4-morpholin-4-yl-phenyl)-butan-1-one, phenylglyoxylic acid methyl ester, ethylanthraquinone, and phenanthrenequinone:
benzophenone compounds such as benzophenone, 2-methylbenzophenone, 3-methylbenzophenone, 4-methylbenzophenone, 2,4,6-trimethylbenzophenone, 4-phenylbenzophenone, 4-(methylphenylthio)phenylphenylmethane, methyl-2-benzophenone, 1-[4-(4-benzoylphenylsulfanyl)phenyl]-2-methyl-2-(4-methylphenylsulfonyl)propan-1-one, 4,4′-bis(dimethylamino)benzophenone, 4,4′-bis(diethylamino)benzophenone, N,N′-tetramethyl-4,4′-diaminobenzophenone, N,N′-tetraethyl-4,4′-diaminobenzophenone, and 4-methoxy-4′-dimethylaminobenzophenone;
acylphosphine oxide compounds such as bis(2,4,6-trimethylbenzoyl)-phenylphosphine oxide, 2,4,6-trimethylbenzoyldiphenylphosphine oxide, ethyl-(2,4,6-trimethylbenzoyl)phenylphosphinate, and bis(2,6-dimethoxybenzoyl)-2,4,4-trimethylpentylphosphine oxide;
thioxanthone compounds such as thioxanthone, 2-chlorothioxanthone, 2,4-diethylthioxanthone, isopropylthioxanthone, 1-chloro-4-propylthioxanthone, 3-[3,4-dimethyl-9-oxo-9H-thioxanthone-2-yl]oxy]-2-hydroxypropyl-N,N,N-trimethylammonium chloride, and fluorothioxanthone;
acridone compounds such as acridone and 10-butyl-2-chloroacridone;
oxime esters such as 1,2-octanedione 1-[4-(phenylthio)-2-(O-benzoyloxime)], and ethanone 1-[9-ethyl-6-(2-methylbenzoyl)-9H-carbazol-3-yl]-1-(O-acetyloxime), and 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, and 2-(2,4-dimethoxyphenyl)-4,5-diphenyl imidazole dimer; and
acridine derivatives such as 9-phenylacridine and 1,7-bis(9,9′-acridinyl)heptane, titanocene compounds such as bis(η5-2,4-cyclopentadien-1-yl)-bis(2,6-difluoro-3-(1H-pyrrol-1-yl)-phenyl)titanium, and germanium photoinitiators such as bis-(4-methoxybenzoyl)diethylgermanium.

Among these, a photopolymerization on initiator having an absorption coefficient (mL/g·cm) at 405 nm of 100 or more is preferable for improving the dark part curability, and 500 or more is more preferable.

Specifically, acylphosphine oxide compounds such as bis(2,4,6-trimethylbenzoyl)-phenylphosphine oxide (absorption coefficient at 405 nm=899) and 2,4,6-trimethylbenzoyldiphenylphosphine oxide (absorption coefficient at 405 nm=165), titanocene compounds such as bis(η5-2,4-cyclopentadien-1-yl)-bis(2,6-difluoro-3-(1H-pyrrol-1-yl)-phenyl)titanium (absorption coefficient at 405 nm=1197), and germanium-based photopolymerization initiators such as ivocerin (absorption coefficient at 405 nm=1741) are preferred because of high dark part curability.

The content of Component (D) is preferably from 0.01 to 15 parts by weight and more preferably from 0.1 to 10 parts by weight, with respect to a total amount of 100 parts by weight of Component (A).

When the content of Component (D) is set to 0.01 parts by weight or more, the dark part curability of the composition can be sufficiently improved. When the content of Component (D) is set to 15 parts by weight or less, the curability of the bottom part of the coating film can be improved.

### 4-2. Antioxidant

An antioxidant may be formulated for the purpose of improving the durability such as heat resistance and weather resistance of the cured product.

Examples of antioxidants include phenol-based antioxidants and sulfur-based antioxidants.

Examples of phenol-based antioxidants include hindered phenols such as di-t-butylhydroxytoluene. Examples of commercially available products include AO-20, AO-30, AO-40, AO-50, AO-60, AO-70, and AO-80, each manufactured by ADEKA Corporation.

Examples of sulfur-based antioxidants include thioether-based compounds, and examples of commercially available products include AO-23, AO-412S, and AO-503A, each manufactured by ADEKA Corporation.

These may be used singly or in combination of two or more. Examples of preferred combinations of these antioxidants includes a combination of a phenol-based antioxidant and a sulfur-based antioxidant.

The content of the antioxidant may be appropriately set according to the purpose, and is preferably from 0.01 to 5 parts by weight and more preferably from 0.1 to 1 part by weight, with respect to a total amount of 100 parts by weight of Component (A).

When the content is set to 0.1 parts by weight or more, the durability of the composition can be improved. When the content is set to 5 parts by weight or less, the curability and the adhesiveness can be made favorable.

### 4-3. Ultraviolet Absorber

An ultraviolet absorber may be formulated for the purpose of improving the light resistance of the cured product.

Examples of ultraviolet absorbers include triazine-based ultraviolet absorbers such as TINUVIN400, TINUVIN405, TINUVIN460, and TINUVIN479, and benzotriazole-based ultraviolet absorbers such as TINUVIN900, TINUVIN928, and TINUVIN1130, each manufactured by BASF.

The content of the ultraviolet absorber may be appropriately set according to the purpose, and is preferably from 0.01 to 5 parts by weight and more preferably from 0.1 to 1 part by weight, with respect to a total amount of 100 parts by weight of Component (A). When the content is set to 0.01 parts by weight or more, the light resistance of the cured product can be improved. When the content is set to 5 parts by weight or less, the curability of the composition can be made excellent.

### 4-4. Silane Coupling Agent

A silane coupling agent may be formulated for the purpose of improving the interfacial adhesive strength between the cured product and a substrate.

The silane coupling agent is not particularly limited as long as it can contribute to improving the adhesiveness to a substrate.

Examples of silane coupling agents include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-(meth)acryloxypropylmethyldimethoxysilane, 3-methacryloxypropyltrimethoxysilane, 3-(meth)acryloxypropylmethyldiethoxysilane, 3-(meth)acryloxypropyltriethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropylmethyldimethoxysilane, and 3-mercaptopropyltrimethoxysilane. As for the silane coupling agent, only one of the aforementioned compounds may be used, or two or more may be used in combination.

The formulation ratio of the silane coupling agent may be appropriately set according to the purpose, and is preferably from 0.1 to 10 parts by weight and more preferably from 1 to 5 parts by weight with respect to a total amount of 100 parts by weight of Component (A).

When the formulation ratio is set to 0.1 parts by weight or more, the adhesive strength of the composition can be improved. When the formulation ratio is set to 10 parts by weight or less, it is possible to prevent the adhesive strength from changing over time.

### 4-5. Surface Modifier

A surface modifier may be formulated in the composition of the present disclosure for the purpose of improving the leveling properties during application or improving the slip resistance of the cured product to improve the scratch resistance.

Examples of surface modifiers include surface conditioners, surfactants, leveling agents, antifoaming agents, slipperiness imparting agents, and antifouling agents, and known surface modifiers can be used.

Among them, silicone-based surface modifiers and fluorine-based surface modifiers are preferred. Specific examples include silicone-based polymers and oligomers having a silicone chain and a polyalkylene oxide chain, silicone-based polymers and oligomers having a silicone chain and a polyester chain, fluorine-based polymers and oligomers having a perfluoroalkyl group and a polyalkylene oxide chain, and fluorine-based polymers and oligomers having a perfluoroalkyl ether chain and a polyalkylene oxide chain.

A surface modifier having an ethylenically unsaturated group, preferably a (meth)acryloyl group, in the molecule may also be used for the purpose of, for example, increasing the durability of lubricity.

The content of the surface modifier is preferably from 0.01 to 1.0 part by weight with respect to a total amount of 100 parts by weight of Component (A). When the content is within the aforementioned range, the surface smoothness of the cured film becomes excellent.

### 4-6. Polymerization Inhibitor

A polymerization inhibitor can be formulated in the composition of the present disclosure for the purpose of, for example, improving the storage stability.

Examples of polymerization inhibitors include organic polymerization inhibitors, inorganic polymerization inhibitors, and organic salt-based polymerization inhibitors.

Specific examples of organic polymerization inhibitors include phenol compounds such as hydroquinone, tert-butylhydroquinone, hydroquinone monomethyl ether, 2,6-di-tert-butyl-4-methylphenol, 2,4,6-tri-tert-butylphenol, and 4-tert-butylcatechol, quinone compounds such as benzoquinone, stable radicals such as galvinoxyl, 2,2,6,6-tetramethylpiperidine-1-oxyl, and 4-hydroxy-2,2,6,6-tetramethylpiperidine-1-oxyl, phenothiazine, and N-nitroso-N-phenylhydroxylamine ammonium.

Specific examples of inorganic polymerization inhibitors include copper chloride, copper sulfate, and iron sulfate.

Specific examples of organic salt-based polymerization inhibitors include nitroso compounds such as an N-nitroso-N-phenylhydroxylamine⋅aluminum salt and ammonium N-nitrosophenylhydroxylamine, and copper dibutyldithiocarbamate.

Among these, stable radicals and nitroso compounds are preferred in that the coloring of the composition is small and the storage stability can be improved by preventing thickening and gelling of the composition.

The content of the polymerization inhibitor may be appropriately set according to the purpose, and is preferably from 0.0005 to 1 part by weight and more preferably from 0.001 to 0.5 parts by weight, with respect to a total amount of 100 parts by weight of Component (A). When the content is set to 0.0005 parts by weight or more, the thermal stability and light stability of the composition can be enhanced. When the content is set to 1 part by weight or less, the composition can be made excellent in photocurability.

### 5. Usage Method

As for the method of using the composition of the present disclosure, a conventional method may be followed.

When using the composition of the present disclosure as a coating agent, examples include a method of applying the composition of the present disclosure to a substrate and irradiating a surface at which the composition is applied with an active energy ray.

When using the composition of the present disclosure as an adhesive, examples include a method of applying the composition of the present disclosure to a substrate and affixing with another substrate, followed by irradiating an active energy ray from a side of either of the substrates.

The composition of the present disclosure can be preferably used as an active energy ray-curable composition with dark part curability.

When using the composition as a coating agent, examples include a method of manufacturing a substrate having a cured product, including applying the composition of the present disclosure to a substrate having a dark part, followed by irradiating an active energy ray from a side of a part at which the composition is applied.

According to this method, it is possible to manufacture a substrate in which a cured product of the composition of the present disclosure is formed at a surface of a substrate having a dark part.

Specific examples of substrates having a dark part in this case include electronic parts when the composition of the present disclosure is used as a moisture-proof coating agent or the like, and the back of ICs (integrated circuits), resistors, or the like, constituting electronic parts corresponds to the dark part.

Examples of a method of using the composition as an adhesive include a method of manufacturing a layered body having a dark part. For example, the manufacturing method preferably includes Step 1 and Step 2 below sequentially:
Step 1: applying the composition of the present disclosure to a substrate having no dark part, and affixing a side of the substrate having no dark part at which the composition of the present disclosure is applied to a substrate having a dark part, or applying the composition of the present disclosure to a substrate having a dark part, and affixing a side of the substrate having a dark part at which the composition of the present disclosure is applied to a substrate having no dark part, and
Step 2: after Step 1, irradiating an active energy ray from a side of the substrate having no dark part or from a side of the substrate having a dark part

According to this method, it is possible to manufacture a layered body having a dark part, which is composed of a substrate having no dark part, a cured product of the composition of the present disclosure, and a substrate having a dark part.

Examples of active energy rays for curing the composition of the present disclosure include ultraviolet rays, visible light, and electron beams, and ultraviolet rays are preferred.

Examples of ultraviolet irradiation devices include high-pressure mercury lamps, metal halide lamps, ultraviolet (UV) electrodeless lamps, and light emitting diodes (LEDs).

The irradiation energy may be appropriately set according to the kind of active energy rays or the formulation composition. In the case of using a high-pressure mercury lamp as an example, the irradiation energy is preferably from 50 to 50,000 mJ/cm² and more preferably from 200 to 10,000 mJ/cm².

In order to improve the dark part curability, it is preferable to use a substrate with high light reflectance as an adherend. Specific examples include plastics and inorganic materials.

Examples of plastics include polyethylene, polypropylene, polycarbonate, polyethylene terephthalate, polyethylene naphthalate, acrylic polymer, acrylic/styrene copolymer, aliphatic, polyamide (nylon), aromatic polyamide, polyurethane, polyimide, ethylene-vinyl acetate copolymer, polyvinyl chloride, polyvinylidene chloride, polycycloolefin, polystyrene, transparent ABS resin, chlorinated polypropylene, polyacetal, polyvinyl alcohol, and cellulose ester such as triacetyl cellulose.

Examples of inorganic materials include ceramic materials such as glass, metals such as aluminum, stainless steel, copper, silver, iron, tin, and chromium, and metal oxides such as zinc oxide (ZnO) and indium tin oxide (ITO).

The composition of the present disclosure is excellent in dark part curability when using a substrate with low light reflectance, and can effectively undergo dark part curing even when using such a material.

The substrate with low light reflectance in the present disclosure means a substrate with a light reflectance, which is a ratio of reflected light to incident light, of less than 10%. In the present disclosure, a black substrate or the like having a light reflectance of less than 1% or almost zero is also referred to as a “non-reflective substrate”.

Examples of substrates with low light reflectance include plastics and metals colored by colors with low light reflectance, and plastics and metals having a coating layer colored by colors with low light reflectance at the surface.

In order to improve the dark part curability, it is also effective to diagonally or laterally irradiate a surface at which the composition is applied with an active energy ray.

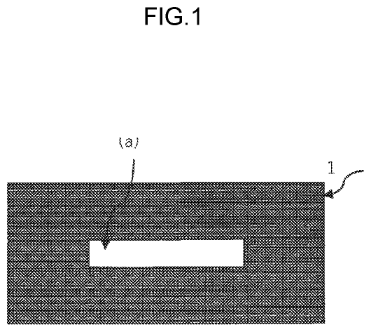

FIG. 1 schematically shows a top view of a specimen used in the dark part curability test. The specimen has a non-reflective substrate 1 and a punched portion (a).

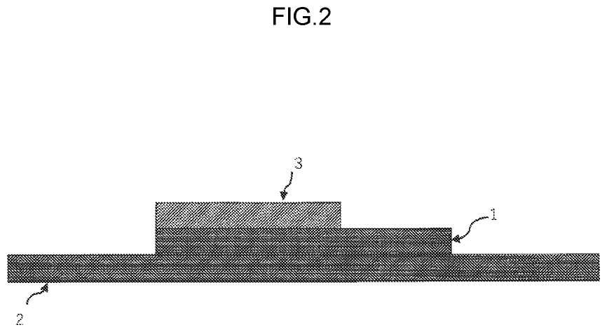

FIG. 2 schematically shows a side view of a specimen used in the dark part curability test. The specimen has a non-reflective substrate 1, a non-reflective or reflective substrate 2, and a light shielding member 3.

Examples of the non-reflective substrate 1 include a black NBR (acrylonitrile-butadiene rubber). Examples of the non-reflective or reflective substrate 2 include a black NBR in the case of non-reflective substrate, and an aluminum-deposited PET (polyethylene terephthalate) film in the case of reflective substrate. Examples of the light shielding member 3 include a resist pattern.

The dark part curability test can be performed, for example, by the following procedure.

The punched portion (a) is provided by punching the non-reflective substrate 1 with a die having a predetermined shape. The non-reflective or reflective substrate 2 is affixed to one side of the non-reflective substrate 1 having the punched portion (a), to prepare a sample having a recessed shape. The active energy ray-curable composition is poured into the portion having the recessed shape, and the light shielding member 3 is laminated to obtain a specimen for the dark part curability test. Next, the specimen is irradiated with ultraviolet rays to prepare a cured product. The uncured product is removed from the obtained cured product, and the length of the cured portion extending from the ultraviolet irradiated portion toward the non-irradiated portion is measured, and used as an index of dark part curability.

### 6. Application

The present invention relates to an active energy ray-curable composition, and preferably relates to so-called an active energy ray-curable composition with excellent dark part curability, which can be cured by irradiation with active energy rays such as ultraviolet rays even at a site that is not directly irradiated with active energy rays.

Since the composition of the present disclosure is excellent in dark part curability, the composition can be preferably used for adhesion, sealing, coating, or the like, of adherends having a three-dimensional shape that tends to create a dark part. In particular, the composition of the present disclosure is excellent in dark part curability when using substrates with low light reflectance, so the composition is suitable as adhesives, sealants, or coating agents when using, as substrates, colored plastics with low light reflectance, plastics or metals colored by paints with low light reflectance, electronic parts, or the like. Furthermore, the composition of the present disclosure can be preferably used for adhesion, sealing, coating, or the like, of adherends with low light reflectance having a three-dimensional shape that tends to create a dark part.

Examples of applications that require dark part curability include adhesion and sealing of various members, adhesion between substrates and electronic elements, and moisture-proof insulation coating for electronic parts in the manufacture of display devices such as liquid crystal displays, plasma displays, and organic EL displays, and adhesion and sealing of openings, end faces, and their peripheral portions in the manufacture of battery cases.

Specifically, in the manufacture of display devices, a dark part where light does not reach is created in the adhesion of constituent members. More specifically, transparent protective plates of touch panels are provided with band-shaped light shielding part at the outermost edge thereof in order to improve contrast of displayed images. Black resins are generally used for the light shielding part and the light reflectance is as low as less than 1%, so high dark part curability is required.

As another specific example, in moisture-proof insulation coating agents for electronic parts, the liquid composition wraps around the back side of electronic parts such as ICs and resistors, creating a dark part where light does not reach. These electronic parts are often black and the light reflectance is as low as less than 1%, so high dark part curability is required.

### EXAMPLE

Examples and Comparative Examples are shown below to describe the present invention more specifically.

In the following, “parts” means parts by weight.

### 1. Examples 1 to 16, Comparative Examples 1 to 3

### 1) Production of Active Energy Ray-Curable Composition

The compounds shown in Table 1 below were stirred and mixed at 60° C. at the ratios shown in Table 1 to produce active energy ray-curable compositions.

### 2) Evaluation Method

Using the obtained compositions, the following evaluations were performed. The results are shown in Table 1.

### (1) Dark Part Curability (Non-Reflective Substrate)

A black NBR (acrylonitrile-butadiene rubber) having a thickness of 0.5 mm (width of 20 mm and length of 100 mm) [1 in FIG. 1] was punched out with a rectangular cutting die having a width of 5 mm and a length of 50 mm [(a) in FIG. 1]. Subsequently, the rubber [1 in FIG. 2] was affixed to a black NBR having a thickness of 0.5 mm (width of 100 mm and length of 200 mm) [2 in FIG. 2] using a double-sided tape to prepare a rubber sample having a recessed shape.

The obtained active energy ray-curable composition was poured into the portion having the recessed shape, and a resist pattern (light shielding portion) [3 in FIG. 2] having an O.D. value (optical density) of 4 or more was laminated with 10 mm left from the edge so that bubbles did not enter, to obtain a specimen for the dark part curability test.

Next, this specimen was irradiated with ultraviolet rays by using a metal halide lamp manufactured by Eye Graphics Co., Ltd. and adjusting such that the intensity of the ultraviolet region (UV-A) centered at 365 nm was 200 mW/cm² and the integrated light intensity was 100 mJ/cm². This operation was repeated 20 times to achieve a total integrated light intensity of 2,000 mJ/cm², thereby a cured product was produced.

The obtained cured product was immediately washed with methanol to remove the uncured product. Subsequently, the length of the cured portion extending from the ultraviolet irradiated portion toward the non-irradiated portion was measured, and used as an index of dark part curability.

### (2) Dark Part Curability (Reflective Substrate)

A black NBR having a thickness of 0.5 mm (width of 20 mm and length of 100 mm) [1 in FIG. 1] was punched out with a rectangular cutting die having a width of 5 mm and a length of 50 mm [(a) in FIG. 1]. Subsequently, the rubber was affixed to an easy-adhesive PET (polyethylene terephthalate) film [Cosmo Shine A-4360 manufactured by Toyobo Co., Ltd., film thickness of 50 μm] [2 in FIG. 2] using a double-sided tape to prepare a rubber sample having a recessed shape.

The obtained active energy ray curable composition was poured into the portion having the recessed shape, and an aluminum-deposited PET (polyethylene terephthalate) film [manufactured by AS ONE Corporation, trade name: aluminum-deposited PET film, film thickness of 12 μm] [3 in FIG. 2] was laminated with 10 mm left from the edge so that bubbles did not enter. Next, aluminum plates having a thickness of 0.1 mm were each placed under the easy-adhesive PET film and on the aluminum-deposited PET film of the specimen, to obtain a specimen for the dark part curability test.

Next, this specimen was irradiated with ultraviolet rays by using a metal halide lamp manufactured by Eye Graphics Co., Ltd. and adjusting such that the intensity of the ultraviolet region (UV-A) centered at 365 nm was 200 mW/cm² and the integrated light intensity was 100 mJ/cm². This operation was repeated 20 times to achieve a total integrated light intensity of 2,000 mJ/cm², thereby a cured product was produced.

The obtained cured product was immediately washed with methanol to remove the uncured product. Subsequently, the length of the cured portion extending from the ultraviolet irradiated portion toward the non-irradiated portion was measured, and used as an index of dark part curability.

### (3) Storage Stability

The obtained active energy ray-curable composition was stored at room temperature in a state completely shielded from light, and the days until gelation occurred were counted and used as an index of storage stability.

TABLE 1

| | Component (A) | | | | | | Component (B) | | | |
|---|---|---|---|---|---|---|---|---|---|---|
| | M-1200 | NDDA | HDDA | ACMO | M-305 | M-313 | OB | EFS | SC200 | K-B |
| Example 1 | 30 | 70 | | | | | 0.014 | | | |
| Example 2 | 30 | 70 | | | | | 0.014 | | | |
| Example 3 | 30 | 70 | | | | | 0.014 | | | |
| Example 4 | 30 | 70 | | | | | 0.014 | | | |
| Example 5 | 30 | 70 | | | | | 0.014 | | | |
| Example 6 | 30 | 70 | | | | | 0.014 | | | |
| Example 7 | 30 | | 70 | | | | 0.014 | | | |
| Example 8 | 30 | 40 | | 30 | | | 0.014 | | | |
| Example 9 | 10 | | | 30 | 60 | | 0.014 | | | |
| Example 10 | 30 | 50 | | | | 20 | 0.014 | | | |
| Example 11 | 30 | 50 | | | | 20 | 0.014 | | | |
| Example 12 | 30 | 50 | | | | 20 | 0.014 | | | |
| Example 13 | 30 | 50 | | | | 20 | 0.014 | | | |
| Example 14 | 30 | 50 | | | | 20 | | 0.014 | | |
| Example 15 | 30 | 50 | | | | 20 | | | 0.014 | |
| Example 16 | 30 | 50 | | | | 20 | | | | 0.014 |
| Comparative | 30 | 70 | | | | | | | | |
| Example 1 | | | | | | | | | | |
| Comparative | 30 | 70 | | | | | 0.014 | | | |
| Example 2 | | | | | | | | | | |
| Comparative | 30 | 70 | | | | | | | | |
| Example 3 | | | | | | | | | | |

| | | | | | | | | | | Dark Part | | Storage | |
|---|---|---|---|---|---|---|---|---|---|---|---|---|---|
| | Component (C) | | | | Component (D) | | | | Other | Curability (mm) | | Stability | |
| | TEH | BD-1 | TPP | TIDP | BAPO | UV-784 | MAPO | IV | Q-1301 | Non-Reflective | Reflective | (day) | |
| Example 1 | 10 | | | | | | | | | 6 | 10 | >14 | days |
| Example 2 | 10 | | | | 0.4 | | | | | 15 | 35 | >14 | days |
| Example 3 | | 10 | | | 0.4 | | | | | 4 | 10 | >14 | days |
| Example 4 | 10 | | | | | 0.01 | | | | 21 | 40 | >14 | days |
| Example 5 | 10 | | | | | | 0.5 | | | 12 | 20 | >14 | days |
| Example 6 | 10 | | | | | | | 0.02 | | 16 | 36 | >14 | days |
| Example 7 | 10 | | | | 0.4 | | | | | 18 | 38 | 12 | days |
| Example 8 | 10 | | | | 0.4 | | | | | 15 | 38 | 3 | days |
| Example 9 | 10 | | | | 0.4 | | | | | 22 | 46 | 1 | day |
| Example 10 | 10 | | | | 0.4 | | | | | 24 | 42 | 1 | day |
| Example 11 | 10 | | | | 0.4 | | | | 0.005 | 21 | 40 | >14 | days |
| Example 12 | | | 10 | | 0.4 | | | | 0.005 | 15 | 32 | >14 | days |
| Example 13 | | | | 10 | 0.4 | | | | 0.005 | 14 | 31 | >14 | days |
| Example 14 | 10 | | | | 0.4 | | | | 0.005 | 22 | 43 | >14 | days |
| Example 15 | 10 | | | | 0.4 | | | | 0.005 | 24 | 42 | >14 | days |
| Example 16 | 10 | | | | 0.4 | | | | 0.005 | 10 | 25 | >14 | days |
| Comparative | | | | | 0.4 | | | | | 0 | 0 | >14 | days |
| Example 1 | | | | | | | | | | | | | |
| Comparative | | | | | 0.4 | | | | | 1 | 2 | >14 | days |
| Example 2 | | | | | | | | | | | | | |
| Comparative | 10 | | | | 0.4 | | | | | 2 | 3 | >14 | days |
| Example 3 | | | | | | | | | | | | | |

The number for each component in Table 1 means the number of parts, and the abbreviations mean the following.

### Component (A)

M-1200: polyester-based urethane acrylate, “Aronix M-1200”, manufactured by Toagosei Co., Ltd.
NDDA: 1,9-nonanediol diacrylate, “Fancryl FA-129AS”, manufactured by Hitachi Chemical Co., Ltd.
HDDA: 1,6-hexanediol diacrylate, “NK Ester A-HD-N”, manufactured by Shin-Nakamura Chemical Co., Ltd.
ACMO: acryloyl morpholine, “ACMO”, manufactured by KJ Chemicals Co., Ltd.
M-305: a mixture of pentaerythritol tri- and tetraacrylates, “Aronix M-305”, manufactured by Toagosei Co., Ltd.
M-313: a mixture of di- and triacrylates of ethylene oxide adducts of isocyanuric acid, “Aronix M-313”, manufactured by Toagosei Co., Ltd.

### Component (B)

OB: 2,5-thiophenediylbis(5-tert-butyl-1,3-benzoxazole), “Tinopal OB”, maximum emission wavelength between 430 and 500 nm=432 nm, manufactured by BASF Japan
EFS: “Nikkafluor EFS”, maximum emission wavelength between 430 and 500 nm=440 nm, manufactured by Nippon Kagaku Kogyosho
SC200: “Nikkafluor SC200”, maximum emission wavelength between 430 and 500 nm=440 nm, manufactured by Nippon Kagaku Kogyosho
K-B: 4-methyl-7-diethylaminocoumarin, “KAYALIGHT B”, not show maximum emission between 430 and 500 nm (maximum emission wavelength=410 nm), manufactured by Nippon Kayaku

The emission wavelength of Component (B) was determined by preparing a tetrahydrofuran solution (concentration of 0.002% by weight) of each compound, and measuring the emission spectrum of each compound at an excitation light wavelength of 365 nm using a spectrofluorophotometer FP-750 [manufactured by JASCO Corporation].

### Component (C)

TEH: tin (II) 2-ethylhexanoate, a reagent manufactured by Tokyo Chemical Industry Co., Ltd.
BD-1: 1,4-bis(3-mercaptobutyryloxy)butane, “Karenz BD-1”, manufactured by Showa Denko Co., Ltd.
TPP: triphenylphosphine, “Hokuko TPP”, manufactured by Hokko Chemical Industry Co., Ltd.
TIDP: triisodecyl phosphite, “ADEKA STAB 3010”, manufactured by ADEKA Co., Ltd.

### Component (D)

BAPO: bis(2,4,6-trimethylbenzoyl)-phenylphosphine oxide, “Omnirad 819”, manufactured by IGM Resin
UV-784: bis(η5-2,4-cyclopentadien-1-yl)-bis(2,6-difluoro-3-(1H-pyrrol-1-yl)-phenyl)titanium, “DAIDO UV-CURE 784”, manufactured by Daido Chemical Industry Co., Ltd.
MAPO: 2,4,6-trimethylbenzoyldiphenylphosphine oxide, “Omnirad TPO”, manufactured by IGM Resin
IV: bis-(4-methoxybenzoyl)diethylgermanium, “IVOCERIN”, manufactured by IVOCLAR VIVADENT

### Other Component

Q-1301: N-nitrosophenyl hydroxylamine aluminum salt, “Cupferron Q-1301”, manufactured by FUJIFILM Wako Pure Chemical Corporation

### 3) Results

As is clear from the results of Examples 1 to 16, the composition of the present disclosure was excellent in dark part curability. Although each of the compositions of Examples 8 to 10 was excellent in dark part curability, the storage stability was about 1 day to 3 days. However, the compositions can be used in applications that do not require long-term storage, such as applications in which each component is formulated at the work site to prepare a composition and the composition is used in a relatively short period of time.

On the other hand, the composition of Comparative Example 1, which includes neither Component (B) nor Component (C), the composition of Comparative Example 2, which does not include Component (C), and the composition of Comparative Example 3, which does not include Component (B), were each insufficient in dark part curability.

### INDUSTRIAL APPLICABILITY

The composition of the present disclosure can be used for various applications in which dark part curability is required, and can be preferably used for adhesives, sealants, or coating agents. Specific examples include adhesives for optical films and members, adhesives for electronic materials, sealants, and moisture-proof coating agents.

Examples of adhesives and sealants for optical films and members particularly include sealants for liquid crystal display elements, and affixing between display bodies and touch panels, and affixing between cover glasses and touch panels.

1. An active energy ray-curable composition, comprising Component (A), Component (B), and Component (C) below,
wherein the active energy ray-curable composition comprises Component (B) at a ratio of from 0.001 to 5 parts by weight and Component (C) at a ratio of from 0.1 to 20 parts by weight, each with respect to a total of 100 parts by weight of Component (A):
Component (A): a compound having an ethylenically unsaturated group, wherein the compound is not a compound that has a linear or branched saturated hydrocarbon group having 1 to 7 carbon atoms without a substituent and that has one (meth)acryloyl group,
Component (B): a fluorescent agent, and
Component (C): a reducing agent.

2. The active energy ray-curable composition according to claim 1, wherein Component (B) comprises a compound that emits visible light with a maximum at a wavelength of from 400 to 500 nm.

3. The active energy ray-curable composition according to claim 1, wherein Component (C) comprises a thiol compound.

4. The active energy ray-curable composition according to claim 1, wherein Component (C) comprises a divalent tin compound.

5. The active energy ray-curable composition according to claim 1, wherein Component (C) comprises a trivalent phosphorus compound.

6. The active energy ray-curable composition according to claim 1, further comprising a photoradical polymerization initiator as Component (D), wherein the active energy ray-curable composition comprises Component (D) at a ratio of from 0.01 to 15 parts by weight with respect to a total of 100 parts by weight of Component (A).

7. The active energy ray-curable composition according to claim 6, wherein Component (D) has an absorption coefficient at 405 nm of 100 or more.

8. An active energy ray-curable composition with dark part curability, comprising the composition according to claim 1.

9. A substrate, comprising a cured product of the active energy ray-curable composition with dark part curability according to claim 8, wherein the cured product is formed on a surface of a substrate having a dark part.

10. A layered body, comprising a substrate having no dark part, a cured product of the active energy ray-curable composition with dark part curability according to claim 8, and a substrate having a dark part.

11. A method of manufacturing a substrate having a cured product, comprising applying the active energy ray-curable composition with dark part curability according to claim 8, to a substrate having a dark part, followed by irradiating an active energy ray from a side of a part to which the composition was applied.

12. A method of manufacturing a layered body having a dark part, sequentially comprising Step 1 and Step 2 below:
Step 1: applying the active energy ray-curable composition with dark part curability according to claim 8 to a substrate having no dark part, and affixing a side of the substrate having no dark part at which the active energy ray-curable composition is applied to a substrate having a dark part, or applying the active energy ray-curable composition with dark part curability according to claim 8 to a substrate having a dark part, and affixing a side of the substrate having a dark part at which the active energy ray-curable composition is applied to a substrate having no dark part, and
Step 2: after Step 1, irradiating an active energy ray from a side of the substrate having no dark part or from a side of the substrate having a dark part.
